(19) United States
(12) Patent Application Publication
(10) Pub. No.: US 2007/0227856 A1
(43) Pub. Date: Oct. 4, 2007

(54) PAYMENT SYSTEM FOR A VENDING MACHINE

(75) Inventor: Stig Gopel, Osten (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: National Rejectors, Inc. GmbH, Buxtehude (DE)

(21) Appl. No.: 11/694,185

(22) Filed: Mar. 30, 2007

(30) Foreign Application Priority Data
Apr. 1, 2006 (DE) 10 2006 015 255.7

(51) Int. Cl. G07F 7/04

(52) U.S. Cl. 194/206

(57) ABSTRACT

Payment system for a vending machine with at least one money handling unit, for example a coin validator/money changer, bank note validator, card reader, hopper or the like, a PC, a single adaptor, which comprises a PC interface via which it may be connected to the PC, and which comprises a plurality of vending machine interfaces for different standards via which it may be connected to the money handing units, and PC software via which the money handling units are controlled.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Vending machines are used for the automatic sale of drinks, cigarettes, snacks, tickets or other goods. For the processing of payment, such vending machines use a payment system in which so-called money handling units undertake the handling of payment means, for example a bank note validator for validating bank notes, a coin validator/money changer for validating and returning change in the form of coins or even card reading devices for handling cashless payment means, such as cash cards or credit cards.

These money handling units are connected via specific interfaces to an automatic control system which, as a central control unit, controls payment processes but also the remaining functions of the vending machine, such as for example the dispensing of goods.

In the field of vending machines, specific standards predominate for the interfaces, such as for example MDB (multi-drop bus), SimplexV or CCTalk, which are denoted below as vending machine interfaces. The vending machine interfaces respectively correspond to a specific standard relative to the design of a plug connection, the technical design of the hardware (for example a specific voltage level) and the protocols used for the communication. Thus the widespread MDB standard, for example, uses a supply voltage of 34 volts and a communication protocol with data packets of 9 bits.

Due to the plurality of vending machine interface standards and the widespread desire to upgrade or convert current vending machines with regard to their money handling units or vending machine control systems, a plurality of compatibility problems are programmed-in. These occur, for example, if additional money handling units are to be incorporated for cashless payment or other money handling units are to be used as a result of a currency conversion. In this case, a conventional vending machine control system generally has limited connection possibilities which are set to a specific vending machine interface standard. Moreover, the programming of conventional vending machine control systems is difficult and, even when it is possible to make the connection of a money handling unit of a different standard, has to be adapted in a complicated manner in order to allow the operation of the new money handling unit.

To solve such compatibility problems, it is known from EP 1 045 351, the entire contents of which is incorporated herein by reference, to provide a money handling unit such as a money changer with a plurality of interfaces. To this end, the known money changer uses a plurality of vending machine interfaces which have different standards for connecting to a vending machine control system. Additionally, the money changer has a further vending machine interface which satisfies the MDB standard and which may be connected to the further money handling units satisfying this standard. As a result, the money changer may be connected to different vending machine control systems and may be combined with additional money handling units which, however, have to correspond to the MDB standard.

Proceeding therefrom, it is the object of the invention to provide an easily programmable payment system for a vending machine, in which any money handling units which are equipped with common vending machine interfaces are able to be used.

The invention is based on the recognition that, for controlling the vending machine, no specific microcomputers provided for vending machines and for specific vending machine interfaces are able to be used, but a conventional PC (personal computer) is able to be used, if a practicable solution is found for the connection of money handling units to the PC. Conventional PCs are characterised by high performance, favourable prices and common operating systems and programming languages, due to their wide and increasing distribution, so that programming is possible with relatively little specialised knowledge. Accordingly, there is a great interest in also using conventional PCs for the control of vending machines.

### BRIEF SUMMARY OF THE INVENTION

The payment system for a vending machine according to the invention has at least one money handling unit, for example a coin validator/money changer, bank note validator, hopper, card reader or the like, a PC, a single adaptor which comprises a PC interface via which it may be connected to the PC and which comprises a plurality of vending machine interfaces for different standards via which it may be connected to the money handling units, and PC software via which the money handling units are controlled.

The payment system according to the invention is, therefore, characterised in particular by the money handling units being able to be connected to a PC via a single adaptor regardless of the respective design of their vending machine interfaces, the adaptor being able to be connected to the PC via a conventional PC interface. Moreover, PC software is provided which runs on the PC and via which the money handling units are controlled. By means of the payment system according to the invention it is achieved that one or more of the money handling units may be connected irrespective of its interface to a PC and controlled via PC software. As the PC is connected to the adaptor via a PC interface, no adjustments to the hardware are required on behalf of the PC. Furthermore, a single adaptor is sufficient to control a plurality of money handling units.

A coin validator/money changer, a hopper, a bank note validator and/or a card reader are provided, for example, as a money handling unit. Depending on the requirements of the vending machines, the payment system may consequently be equipped exclusively for the use of coins, bank notes or cashless payment means or even a combination thereof.

According to a preferred embodiment, the adaptor comprises vending machine interfaces for at least two of the MDB, CCTalk or SimplexV standards. It is, however, provided to connect the money handling units which satisfy at least one of these standards, directly to the adaptor. Moreover, the adaptor may respectively comprise a plurality of interfaces of one standard, so that a larger number of payment systems may also be connected.

The PC interface of the adaptor is preferably a USB interface (universal serial bus), a fire wire interface (IEEE 1394) or an RS-232 interface. In principle, the adaptor may be connected via any interface known in the PC field but, due to the greater operational reliability, a serial interface is preferably used. The known PC interfaces are additionally characterised by a particularly wide distribution.

Preferably, the adaptor is incorporated in a money handling unit. Advantageously, the adaptor may be incorporated in a coin validator/money changer. By the incorporation of the adaptor in a money handling unit, a separate housing for the adaptor may be dispensed with. Instead, the adaptor is produced, together with the corresponding money handling unit, as a compact unit. Optionally, as a result, the subsequent assembly of the payment system is also facilitated in a vending machine as the money handling unit comprising the adaptor may be fitted into the vending machine instead of a conventional money handling unit.

In a preferred embodiment of the invention, the PC software encompasses functions which are initiated by a user program which runs on the PC and via which a connected money handling unit may be controlled with single commands, irrespective of which of the vending machine interfaces it is connected to. It is, therefore, provided to design the payment system such that the programmer of a user program, which is appropriate for the entire vending machine control system, is able to fall back on functions stored in the PC software, which are initiated by the user program. The stored functions control a connected money handling unit irrespective of how the money handling unit is connected in detail to the payment system. To this end, the programmer may use specific configuration commands and requires no detailed knowledge about the money handling units, the connection thereof to the payment system or the protocols necessary for the control of a money handling unit. Instead, the programmer of the user program is able to concentrate on the primary processes which are important for the sales process.

Preferably, the adaptor comprises a microcontroller which undertakes the data communication between the PC and the money handling units by converting the corresponding standards. The microcontroller provided in the adaptor, therefore, communicates via the PC interface with the PC and forwards data or commands in a format accessible for the PC. For the communication with the money handling units, the microcontroller converts the data and commands received or sent via the PC interface, which may be forwarded to the money handling units via the respective vending machine interfaces. Accordingly, the microcontroller also converts data or commands received by the money handling units via the vending machine interfaces.

In a further embodiment of the invention, the PC software encompasses a central payment system control unit which communicates via the adaptor with the money handling units and via further software modules with a user program on the PC, the user program exchanging data about the status of the money handling units and commands via the software modules with the payment system control unit. By this modular construction of the PC software and the provision of a series of software modules for the user program, the communication with the money handling units is further simplified for the programmer of the user program.

In a preferred embodiment of the invention, the PC software is configured as DLL (dynamic link library). A programming of the PC software as a DLL program library represents a possibility which is common in the PC field and is particularly advantageous, namely to make the program code required for the control of the money handling units optionally also available for a plurality of applications.

### BRIEF DESCRIPTION OF SEVERAL VIEWS OF THE DRAWINGS

The invention is described in more detail hereinafter with reference to two embodiments shown in four Figures, in which:

FIG. 1 shows a block diagram of a payment system according to the invention, in which the adaptor is constructed as an independent unit,

FIG. 2 shows a block diagram of a further embodiment of the invention, in which the adaptor is incorporated in a coin validator/money changer,

FIG. 3 shows a block diagram of an adaptor according to the invention with connected money handling units,

FIG. 4 shows a schematic view of the modular construction of the PC software.

### All Figures show very simplified schematic views.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

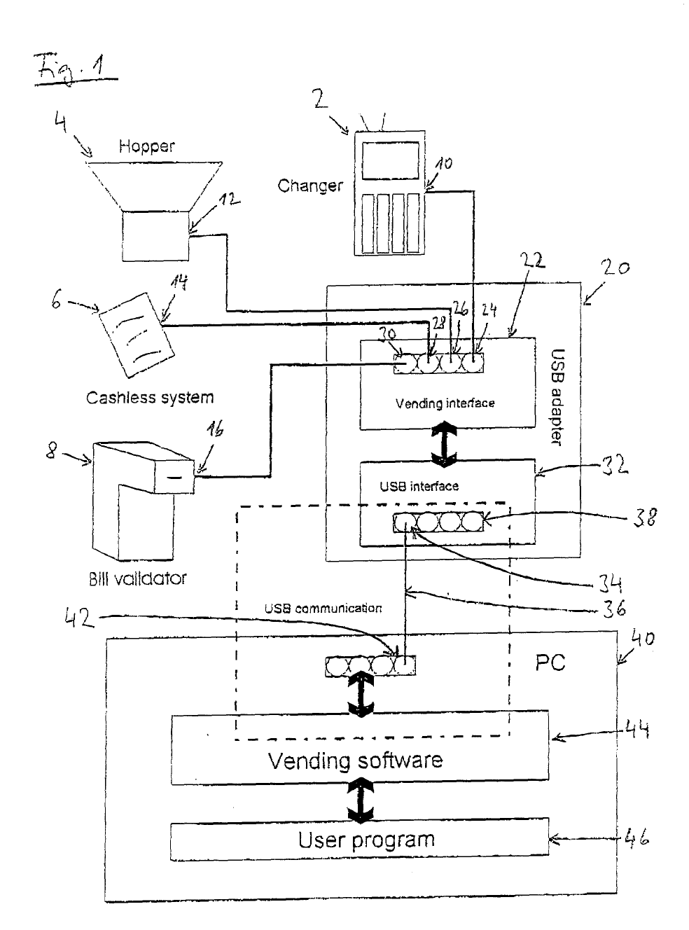

The payment system according to the invention shown in FIG. 1 consists of four money handling units 2-8, an adaptor 20 and a PC 40. As money handling units, a coin validator/money changer 2 (changer), a hopper 4, a card reader device 6 (cashless system) and a bank note validator 8 (bill validator) are connected to the adaptor 20. To this end, each of the money handling units comprises a vending machine interface. In the coin validator/money changer 2 this is a Simplex V interface 10, in the hopper 4 this is a CCTalk interface 12, whilst the card reading device 6 and the bank note validator 8 comprise MDB interfaces 14 and/or 16. The known vending machine interfaces are connected to the adaptor 20 via cables with one respective suitable vending machine interface 24-30, on the adaptor side, of the junction panel 22 (vending interface). The adaptor 20 thus provides a plurality of different vending machine interfaces.

The PC interface 32 (USB interface) is also configured on the adaptor 20, in the present embodiment as a USB interface. As a result, the adaptor 20 in FIG. 1 is also denoted as a USB adaptor.

Moreover, a PC 40 is provided to which, via a free USB slot 42 and a corresponding line 36, the adaptor 20 is connected via the PC interface 32 and the USB slot 34. The communication between the PC 40 and the adaptor 20 takes place, therefore, via the USB connection 36.

A PC program 46 runs on the PC which initiates the control of the money handling units 2-8 by the PC software 44 via specific functions in the software modules 64-70 stored in the PC software 44. The user program 46 is written in a conventional PC programming language and is appropriate for the entire control of the vending machine.

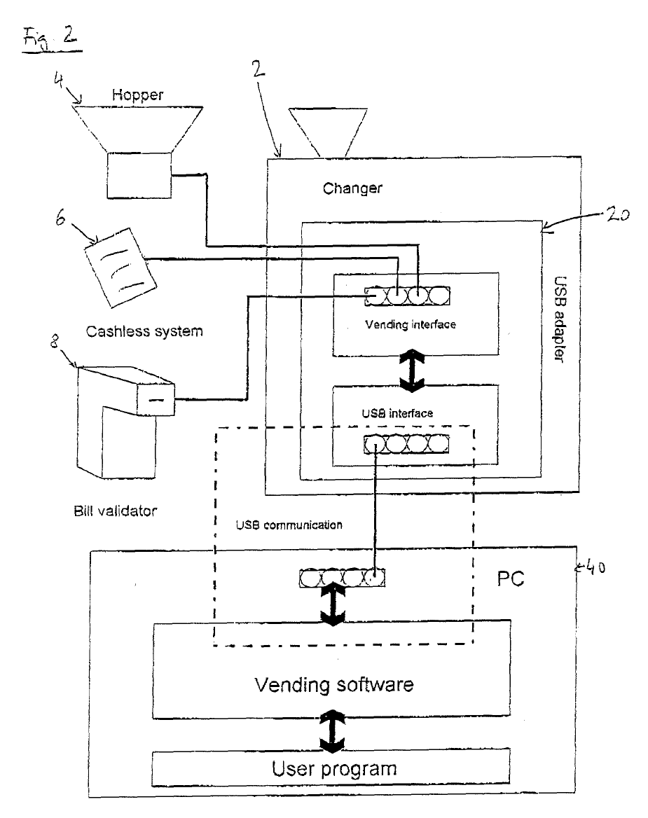

In FIG. 2 a further embodiment of the invention is shown, similar parts being provided with the same reference numerals as in FIG. 11n contrast to the embodiment of FIG. 1, the adaptor 20 is not designed as a separate unit but is located inside the coin validator/money changer 2 (changer). Thus the coin validator/money changer 2 is also not connected to the adaptor 20 via an external line but via an internal connection, not shown. Apart from this, the second embodiment is the same as that of FIG. 1.

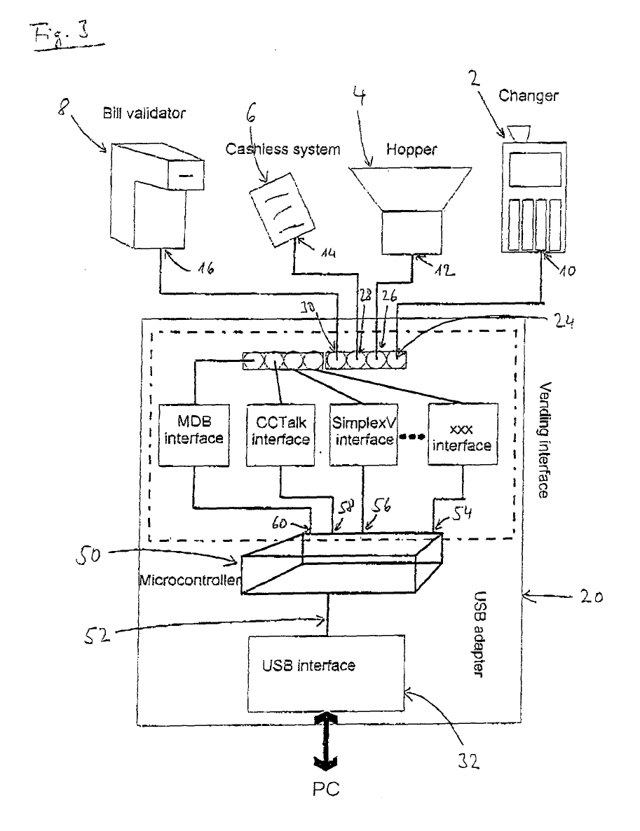

In FIG. 3, the construction of the adaptor 20 of the payment system according to FIG. 1 is shown in more detail. The adaptor 20 is connected to the PC, not shown, via the PC interface 32 (USB interface). A microcontroller 50 is connected via a line 52 to the PC interface 32. Four further connectors 54 to 60 of the microcontroller 50 form, together with the connectors 24-30, the vending machine interfaces (vending interface) of the adaptor 20. The four connectors 54-60 shown of the microcontroller respectively operate a series of connectors of a specific interface standard. For example, the connector 60 is appropriate for money handling units with MDB interfaces, which in the example are connected to the connectors 30 and 28 of the adaptor 20. As in FIG. 1, these are the card reading device 6 and the bank note validator 8. The further vending machine interface 26 of the adaptor 20 satisfies the CCTalk standard and is connected to the CCTalk interface 12 of the hopper 4. Finally, the coin validator/money changer 2 is connected to an interface 24 of the adaptor 20 satisfying the SimplexV standard.

The microcontroller 50 receives information from the PC via the PC interface 32 and translates said information for the individual vending machine interfaces. The microcontroller 50 responds to the individual money handling units 2 to 8 via the connectors 54 to 60. All vending machine interfaces of the adaptor 20 are combined to form a plugboard, not shown, to which the connections for the money handling units may be connected. Via the microcontroller, information from the money handling units 2 to 8 also comes back to the PC via the vending machine interfaces and the respective connectors 54 to 60 and via the PC interface 32.

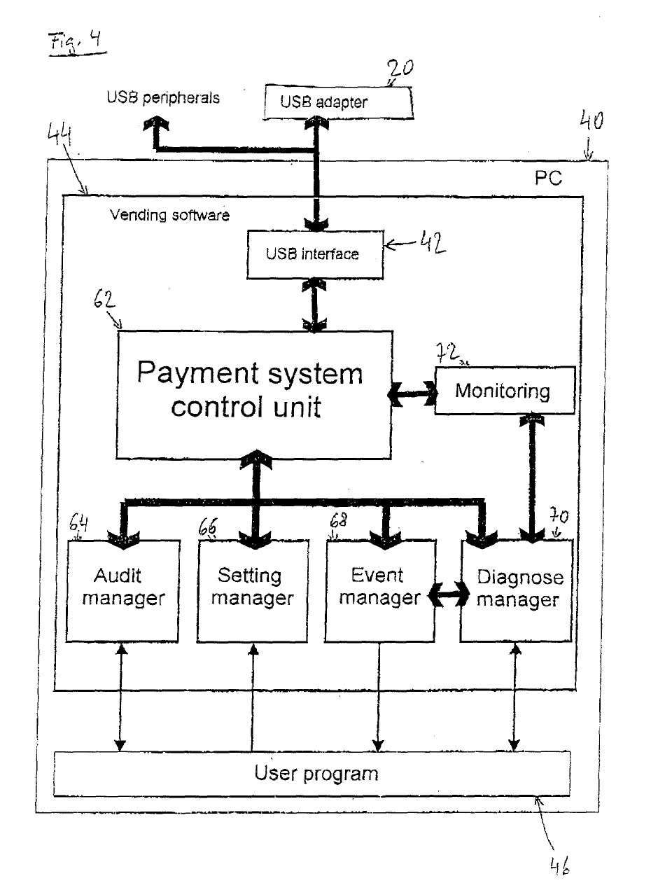

In FIG. 4, the internal construction of the PC software 44 (vending software) which runs on the PC 40 is shown in more detail. The PC software 44 communicates via a USB interface 42 with the adaptor 20. Furthermore, the PC software 44 is connected to a user program 46 which also runs on the PC 40. The user program 46 communicates via four software modules (audit manager 64, settings manager 66, event manager 68 and diagnostic manager 70) with a central payment system control unit 62.

The PC software 44 is implemented as DLL (dynamic link library) and available for all operating systems, such as for example Windows or Linux. It may, however, also be offered as an executable program (exe-data) or in another form.

The PC software 44 automatically recognises the communication protocol required for activating a specific money handling unit and uses said communication protocol accordingly. Alternatively, the protocol to be used for the connected money handling units may also be provided via the user software 46. In this connection, the payment system control unit 62 undertakes typical vending machine control tasks such as initialising, polling, credit management and other activities. By means of the automatic use of the correct communication protocol by the payment system control unit 62 and the individual interfaces 64-70 of the PC software 44 which are independent thereof, the programmer of the user program 46 requires no knowledge for the user program 46 about the interfaces and communication protocols used by the individual money handling units. This considerably simplifies the programming of the vending machines.

The software modules 64-70 shown in FIG. 4, which form the interface to the user program 46, have therefore the following functions in detail. Via the settings manager 66, the user has the possibility of undertaking adjustments to the payment system control unit. Included therewith, for example, are defining inhibit masks for bank notes or coins and providing sales information.

Credit information is, however, forwarded via a further software module, namely the event manager 68. With a money receiving device, for example through the coin validator/money changer or the bank note validator, the new credit status is communicated to the user program via the event manager 68.

A further administrative element of the PC software 44 is the so-called audit manager 64. The audit manager 64 stores so-called audit data such as for example total sales, money received or money dispensed. These data are therefore directly available to the programmer of the user program 46

For error analysis, a further software module of the PC software 44, the monitoring unit 72, stores all communication processes between the adaptor and the money handling units. The corresponding detailed protocols are accessible via the diagnostic manager 70 for the user program 46. This monitoring unit, in combination with the diagnostic manager 70, offers the user the possibility of a very detailed error analysis. The diagnostic manager 70 directly obtains from the payment system control unit 62 additional error messages which are forwarded from the individual money handling units. Included therewith is, for example, a jammed coin in the coin validator/money changer or any other error message.

A typical application of the vending machine according to the invention is described hereinafter by way of example.

When starting up the vending machine, the PC software 44 firstly loads the user program 46. The payment system control unit 62 is started up via the function of the settings manager 66. In the example, the smallest coin of the money changer 2 is blocked. To this end, the user program 46 undertakes a corresponding adjustment via the settings manager 66, which is forwarded to the payment system control unit 62.

The payment system control unit 62 communicates via the PC interface 42 with the adaptor 20 (USB adaptor). It initialises the coin validator/money changer 2 via the SimplexV interface of the coin validator/money changer 2 and blocks the smallest coin of the coin validator/money changer 2. After the initialising of the coin validator/money changer 2 the payment system control unit 62 attempts, via the further interfaces of the adaptor 20, to find further money handling units. In the example, it finds, via the CCTalk interface 26 of the adaptor 20, a hopper 4 and initialises said hopper. The payment system control unit 62 further recognises at the MDB interfaces 28 and 30 the card reading device 6 and/or the bank note validator 8. Both are also initialised for the time being. All initialised money handling units are subsequently continually polled by the payment system control unit 62. It is communicated, via the event manager 68, to the user program 46 which money handling units have been successfully initialised. Furthermore, the credit is set to zero via the event manager 68.

If a customer inserts a bank note into the bank note validator 8, this is recognised by the payment system control unit 62, and the credit is accordingly increased which is, in turn, communicated to the user program 46 via the event manager 68. If a sale is activated by the user program 46, the corresponding credit alteration is forwarded to the payment system control unit 62 via the settings manager 66. The payment system control unit 62 then checks the remaining credit and optionally instructs the coin validator/money changer 2 to pay out the remaining credit. The corresponding payout is communicated from the coin validator/money changer 2 to the payment system control unit 62, the credit accordingly adapted and information about this is forwarded to the user program 46 via the event manager 68.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. Payment system for a vending machine with at least one money handling unit, for example a coin validator/money changer, bank note validator, card leader, hopper or the like, a PC, a single adaptor, which comprises a PC interface via which it may be connected to the PC, and which comprises a plurality of vending machine interfaces for different standards via which it may be connected to the money handling units, and PC software via which the money handling units are controlled.

2. Payment system according to claim 1, characterised in that the adaptor comprises vending machine interfaces for at least two of the MDB, CCTalk or SimplexV standards.

3. Payment system according to claim 1, characterised in that the PC interface of the adaptor is a USB interface (universal serial bus), a fire wire interface (IEEE 1394) or an RS-232 interface.

4. Payment system according to claim 1, characterised in that the adaptor is incorporated in a money handling unit.

5. Payment system according to claim 1, characterised in that the adaptor is incorporated in a coin validator/money changer.

6. Payment system according to claim 1, characterised in that the PC software encompasses functions which are initiated by a user program which runs on the PC, so that the PC software controls a connected money handling unit, irrespective of which vending machine interface it is connected to.

7. Payment system according to claim 1, characterised in that the adaptor comprises a microcontroller which undertakes the data communication between the PC and the money handling units by converting the corresponding standards.

8. Payment system according to claim 1, characterised in that the PC software encompasses a central payment system control unit which communicates via the adaptor with the money handling units and via software modules with a user program, the payment system control unit exchanging data about the status of the money handling units and commands via the software modules with the user program.

9. Payment system according to claim 1, in which the PC software is designed as DLL (dynamic link library).

10. Payment system according to claim 1, in which the PC software is designed as exe- or config data.
